(19) United States
(12) Patent Application Publication
(10) Pub. No.: US 2022/0268506 A1
(43) Pub. Date: Aug. 25, 2022

(54) Expandable Ice Chute

(71) Applicant: William Omeara, Clayton, NC (US)

(72) Inventor: William Omeara, Clayton, NC (US)

(21) Appl. No.: 17/667,800

(22) Filed: Feb. 9, 2022

Related U.S. Application Data
(60) Provisional application No. 63/148,436, filed on Feb. 11, 2021.

(51) Int. Cl. F25C 5/20; B67D 1/00

(52) U.S. Cl. CPC F25C 5/20; B67D 1/0042; F25C 2500/02

(57) ABSTRACT

An ice chute for an ice dispenser is provided. The device includes a cylindrical body, an expandable hose, and a circular body. The expandable hose is sandwiched between the cylindrical body and the circular body. An interior channel is form through the combination of the cylindrical body, the expandable hose, and the circular body. The cylindrical body includes an upper opening. The device may be placed into a collapsed configuration, a partially expanded configuration, or a fully expanded configuration. Pulling the cylindrical body and the circular body in opposite directions extends the expandable hose to place the device in the partially expanded configuration or the fully expanded configuration. In one embodiment, the cylindrical body includes an embedded magnet. In another embodiment, the cylindrical body includes a band with a loop, whereby a fastener clip may engage with the band via the loop.

### CROSS REFERENCE TO RELATED APPLICATIONS

This application claims the benefit of U.S. Provisional Application No. 63/148,436 filed on Feb. 11, 2021. The above identified patent application is herein incorporated by reference in its entirety to provide continuity of disclosure.

### BACKGROUND OF THE INVENTION

The present invention relates to an ice transporting device. More specifically, the present invention provides an expandable ice chute comprising a cylindrical body coupled with an expandable hose to transport ice from an ice dispenser into a desired object or upon a desired surface.

While spending time outside individuals may enjoy consuming a chilled beverage or keeping certain foods within a cold environment. Typically, when camping or tailgating an individual will place their food or beverage within a cooler for the item to maintain a cold temperature. To chill the beverage within the cooler, a user will place an appropriate amount of ice therein. A common way a user acquires the ice for their cooler is to purchase prepackaged ice. The prepackaged ice is usually stored within a plastic bag. To transport the ice from the plastic bag into a desired cooler, the user will open the plastic bag over the cooler and dump the ice into the cooler. However, for individuals who possess a cooler which is small compared to other coolers, the amount of ice that is sold in bags of prepackaged ice might be too much to fit within the cooler with the items the individual wishes to keep cold. Unfortunately, due to the properties of ice, any ice that will not fit within the cooler essentially melts and is wasted. Moreover, some individuals lack the ability to travel to a store to purchase a bag of prepackaged ice. Thus, for the individuals who do not want to waste prepackaged ice or lack the ability to acquire prepackaged ice, they might prefer to fill their cooler with the ice from an ice dispenser.

Filling a cooler with ice from an ice dispenser, such as ones built into a refrigerator, can be a time consuming and frustrating process. Typically, such ice dispensers are designed in such a way that does not allow the dispensed ice to fall into a cooler which is placed on the floor in front of the dispenser. These dispensers have a lower platform that is placed directly under the dispenser mechanism that catches the ice which falls from the dispenser and fails to be placed within a cup. The lower platform allows the unused ice to melt without creating a mess or a hazard that the user must clean up. Moreover, the commonly used ice dispensers only are large enough to place a singular cup within the space between the dispensing mechanism and the lower platform. Due to the size of that space, most coolers will not fit between the dispensing mechanism and the lower platform. This makes it difficult to transfer the ice from the dispenser to the desired cooler.

To extract ice from an ice dispenser for purposes of filling up a cooler or any similar device, typically, individuals must fill a smaller container with the ice from the ice dispenser and transfer the ice from the smaller container into the cooler. Preforming the act of transferring ice from the dispenser into the cooler, the individual will have to fill the smaller container an abundance of times to place enough ice in the cooler to properly chill the items therein. This can take a significant amount of time.

Moreover, transferring ice from a dispenser into a cooler using a small container could lead to some ice falling onto the floor surface. When ice falls upon a floor surface it can be difficult for some individuals to timely remove the ice from the floor. If the individual fails to timely remove the ice from the floor surface, the ice will melt and result in the formation of a puddle of water on the floor surface. When a puddle of water is amassed on a floor surface, there is a risk that the individual, or another individual, may slip on the puddle or even the ice. Such a slip may result in an injury to that individual.

Therefore, there is a defined need amongst the known prior art references for an expandable ice chute that allows ice to be easily transported from a dispenser into a desired object or onto a desired service without having ice fall onto an undesired surface.

### SUMMARY OF THE INVENTION

In view of the foregoing disadvantages inherent in the known types of ice transporting devices now present in the known art, the present invention provides a canister that includes an expandable tube to direct ice from a dispenser into the desired container, such as a cooler.

It is therefore an object of the present invention to provide an expandable tube. The expandable tube can accommodate for the distance between the desired cooler and the ice dispenser. Additionally, the expandable tube becomes more flexible the further a user expands the tube. Such flexibility allows for the expandable tube to be contorted and bent in the desired way to reach the desired location from the dispenser. When the ice enters the expandable tube, via a cylindrical body, the ice will pass through the expandable tube to reach a circular body that is directed to the cooler the individual wants the ice to be placed. This will allow the user to continuously engage a dispenser and remain in the same position as the ice exits the dispenser and enters the desired cooler. The user will not have to repeatedly fill a canister and empty the canister in the cooler. This will not only reduce the amount of time it will take to fill the desired cooler, but it will also limit the risk that any ice falls upon an undesired surface, such as a floor, and create a hazard in which an individual could be harmed or injured.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the expandable ice chute.

FIG. 1B shows a perspective view of an alternative embodiment of the expandable ice chute.

FIG. 2A shows a perspective view of an embodiment of the expandable ice chute in a partial expanded configuration.

FIG. 2B shows a perspective view of an embodiment of the expandable ice chute in a fully expanded configuration.

FIG. 3 shows a perspective view of an embodiment of the expandable ice chute in use.

### DETAILED DESCRIPTION OF THE INVENTION

Reference is made herein to the attached drawings. Like reference numerals are used throughout the drawings to depict like or similar elements of the expandable ice chute. The figures are intended for representative purposes only and should not be limiting in any respect.

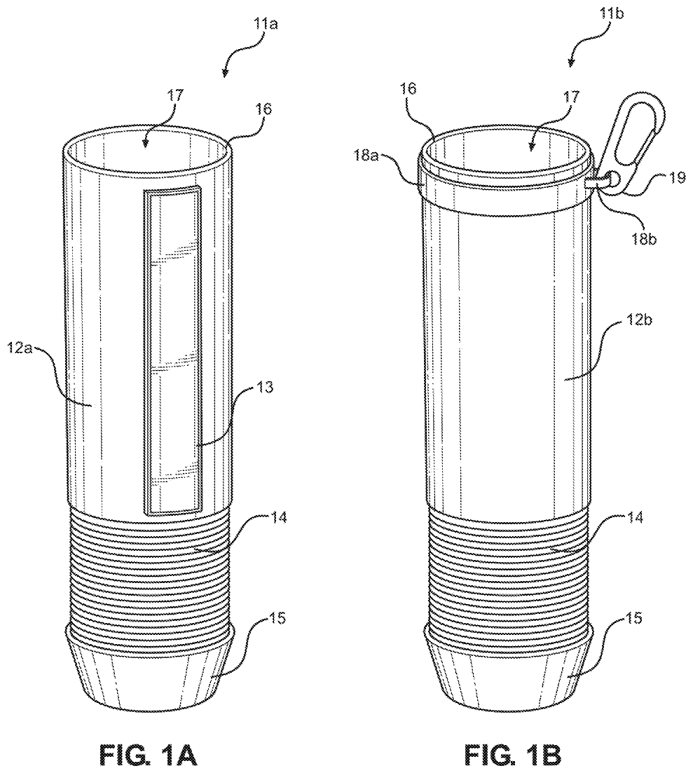

FIG. 1A shows a perspective view of an embodiment of an expandable ice chute. The expandable ice chute 11a comprises a cylindrical body 12a, an expandable hose 14, and a circular body 15. The cylindrical body 12a includes a pair of opposing ends. The cylindrical body 12a is hollow. In one embodiment, the cylindrical body 12a is transparent. In another embodiment, the cylindrical body 12a is composed of glass. In another embodiment, the cylindrical body 12a is composed of plastic. An upper opening 16 defines a first end of the pair of opposing ends. A second end of the pair of opposing ends is attached to the expandable hose 14. The circular body 15 is disposed on the expandable hose 14, whereby the expandable hose 14 is sandwiched between the cylindrical body 12a and the circular body 15. An interior channel 17 is formed through a combination of the cylindrical body 12a, the expandable hose 14, and the circular body 15. Items may enter the expandable ice chute 11a through the upper opening 16. Once inside the expandable ice chute 11a, items will initially pass through the cylindrical body 12a. Next items will pass through the expandable hose 14. Finally, the item will exit the expandable ice chute 11a via the circular body 15. The circular body 15 comprises a hose attaching end and an open end. The hose attaching end and the open end are on opposing ends of the circular body 15. The hose attaching end of the circular body 15 is affixed to the expandable hose 14. In the illustrated embodiment, the circular body 15 tapers away from the hose attaching end towards the hose attaching end, such that a lower end of the circular body 15 comprises a smaller diameter than an upper end of the circular body 15. The tapering of the circular body 15 provides the expandable ice chute 11a with additional precision of the ice that ejects therefrom to assure that the ice is placed in the desired location.

In one embodiment, a magnet 13 is embedded in the cylindrical body 12a. In the shown embodiment, the magnet 13 is confined to a single section of the cylindrical body 12a. In another embodiment, the magnet 13 may surround the entire cylindrical body 12a. The magnet 13 permits a user to secure the expandable ice chute 11a to a surface compatible for a magnet to store the expandable ice chute 11a in a convenient location—such as an ice dispenser—when the expandable ice chute 11a is not in use. Securing the expandable ice chute 11a to the compatible surface allows easy storage and quick access to the expandable ice chute 11a when use is required.

FIG. 1B shows a perspective view of an alternative embodiment of an expandable ice chute. The expandable ice chute 11b comprises a cylindrical body 12b, an expandable hose 14, and a circular body 15. In one embodiment, the cylindrical body 12b is transparent. In another embodiment, the cylindrical body 12b is composed of glass. In another embodiment, the cylindrical body 12b is composed of plastic. The expandable hose 14 is sandwiched between the cylindrical body 12b and the circular body 15. An interior channel 17 is formed through a combination of the cylindrical body 12b, the expandable hose 14, and the circular body 15. Items will pass through an upper opening 16—defining a first end of the cylindrical body 12b—to enter the expandable ice chute 11b. A second end of the of the cylindrical body 12b is connected to the expandable hose 14. Once inside the expandable ice chute 11b, items will initially pass through the cylindrical body 12b. Next items will pass through the expandable hose 14. Finally, the item will exit the expandable ice chute 11b via the circular body 15. The circular body 15 comprises a hose attaching end and an open end. The hose attaching end and the open end are on opposing ends of the circular body 15. The hose attaching end of the circular body 15 is affixed to the expandable hose 14. In the illustrated embodiment, the circular body 15 tapers away from the hose attaching end towards the hose attaching end, such that a lower end of the circular body 15 comprises a smaller diameter than an upper end of the circular body 15. The tapering of the circular body 15 provides the expandable ice chute 11b with additional precision of the ice that ejects therefrom to assure that the ice is placed in the desired location.

In one embodiment, a band 18a encircles the cylindrical body 12b. The band 18a is removable from the cylindrical body 12b. The band 18a is composed from a flexible material. The band 18a further comprises a loop 18b. The loop 18b is disposed on an exterior surface of the band 18a. The loop 18b is designed to accept a fastener clip 19 therethrough. In one embodiment, the fastener clip 19 is a carabiner. The fastener clip 19 secures the expandable ice chute 11b to other objects, such as a cooler, a bag, etc. when the device is not in use and provides quick access to the expandable ice chute 11b when use is required.

In another embodiment, a magnet is embedded in the cylindrical body and a band encircles the cylindrical body. This allows for the expandable ice chute to be secure to a surface compatible for a magnet and to other objects, such as a cooler, a bag, etc. via a fastener clip for storage while the device is not in use.

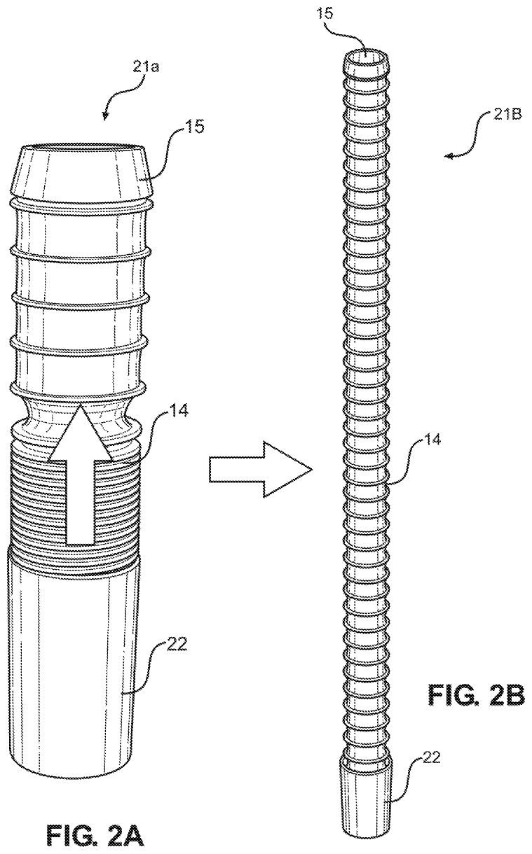

FIGS. 2A and 2B show perspective views of an embodiment of an expandable ice chute in a partial expanded configuration and an embodiment of an expandable ice chute in a fully expanded configuration, respectively. The expandable ice chute 21a may be placed into a collapsed configuration, a partially expanded configuration, or a fully expanded configuration. The expandable ice chute 21a is in the collapsed configuration when the expandable hose 14 has no extension. The expandable ice chute 21b is in a fully expanded configuration when the expandable hose 14 is fully extended. While in the fully expanded configuration, the cylindrical body 22 is the furthest possible distance away from the circular body 15. The expandable ice chute 21a is in the partially expanded configuration when the expandable hose 14 is extended, but not to its fullest capacity. The expandable hose 14 has more flexibility the further separated the circular body 15 and the cylindrical body 22 are from one another. The increase in flexibility permits the expandable ice chute 21a to be contorted to transport the items which pass through the upper opening disposed on the cylindrical body 22 and out of the circular body 15.

In the show embodiment, the expandable hose 14 includes a plurality of ribs. The plurality of ribs is connected via a flexible material. Whereby the flexible material is disposed between each adjacent rib of the plurality of ribs. The plurality of ribs is designed so that adjacent ribs are in contact with each other when the expandable hose 14 is in the collapsed configuration. Additionally, the flexible material between the plurality of ribs compresses inwardly relative to the expandable hose 14. The compression of the flexible material allows the interior channel to remain open and the expandable ice chute functional when in the collapsed configuration. The expandable hose 14 remains in the collapsed configuration until a user selects to place the expandable hose 14 in the partially expanded configuration or the fully expanded configuration. In one embodiment, the expandable hose 14 can retain a desired bent shape when in the partially expanded configuration or the fully expanded configuration.

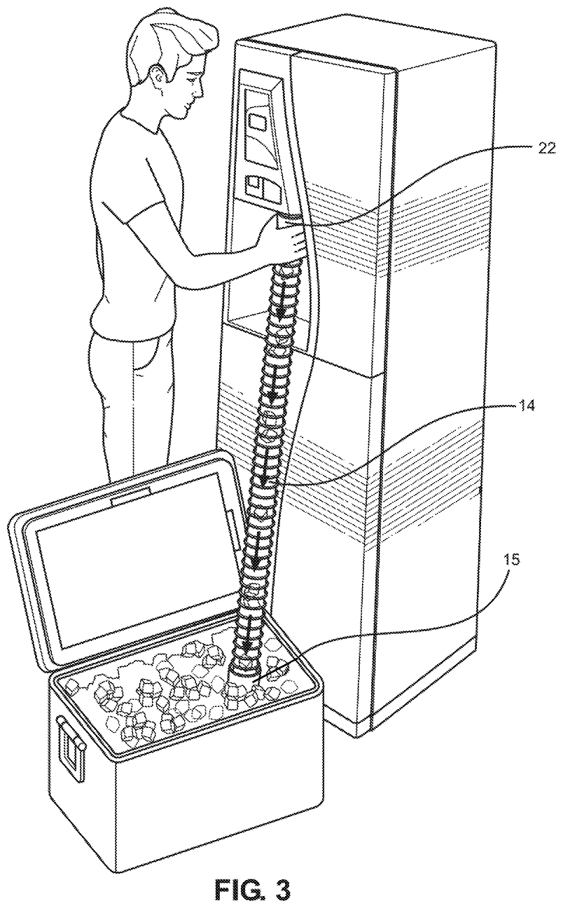

FIG. 3 shows a perspective view of an embodiment of the expandable ice chute in use. In use, the expandable hose 14 may be extended to a desired length. The user will pull the cylindrical body 22 and of the circular body 15 in opposite directions to set the expandable hose 14 to the desired length. The separating of the cylindrical body 22 and the circular body 15 will place the expandable ice chute in either a partially expanded configuration or a fully expanded configuration. The user will place the circular body 15 into, or upon, a desired location for the ice. The user will then place the cylindrical body 22 towards an ice dispenser. The flexibility of the expandable hose 14 while in the partially expanded configuration or the fully expanded configuration permits the user to manipulate the expandable ice chute to transport the ice from the ice dispenser to the desired location, such as a cooler. As the user engages the ice dispenser, the ice will enter the expandable ice chute via the upper opening disposed on the cylindrical body 22. The ice will pass through the cylindrical body 22 and fall down the entire length of the expandable hose 14. The ice will exit the expandable ice chute via the circular body 15. When the user is finished operating the expandable ice chute, the user may place the expandable hose 14 while in the collapsed configuration by pushing the cylindrical body 22 towards the circular body 15. In the collapsed configuration, the user may store the expandable ice chute appropriately. The embodiment of the expandable ice chute with the magnet allows the expandable ice chute to be connected to a compatible surface for storage. The embodiment of the expandable ice chute with the band allows the expandable ice chute to be attached to a compatible object for storage.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An expandable ice chute, comprising:
a cylindrical body comprising a pair of opposing open ends;
an expandable hose disposed on a first open end of the pair of opposing open ends of the cylindrical body;
a second open end of the pair of opposing open ends of the cylindrical body defines an upper opening;
a circular body disposed on the expandable hose;
the circular body comprises a hose attaching end and an open end;
whereby the hose attaching end and the open end are on opposing ends of the circular body wherein the hose attaching end of the circular body is affixed to the expandable hose;
whereby the expandable hose is sandwiched between the cylindrical body and the circular body;
wherein an interior channel is formed through a combination of the cylindrical body, the expandable hose, and the circular body;
the expandable hose may extend to a desired length and subsequently collapsed as desired for storage.

2. The expandable ice chute of claim 1, wherein the expandable hose is composed of a flexible material.

3. The expandable ice chute of claim 1, wherein the cylindrical body comprises an embedded magnet.

4. The expandable ice chute of claim 3, wherein the embedded magnet is confined to a single section of the cylindrical body.

5. The expandable ice chute of claim 1, wherein the cylindrical body comprises a band, whereby the band encircles the cylindrical body.

6. The expandable ice chute of claim 5, wherein the band further comprises a loop; whereby a fastener clip may engage with the band via the loop.

7. The expandable ice chute of claim 5, wherein the band is composed of a flexible material.

8. The expandable ice chute of claim 1, wherein the cylindrical body is transparent.

9. The expandable ice chute of claim 1, wherein the cylindrical body is composed of glass.

10. The expandable ice chute of claim 1, wherein the cylindrical body is composed of plastic.

11. The expandable ice chute of claim 1, wherein the circular body comprises a hose attaching end and an open end; whereby the hose attaching end and the open end are on opposing ends of the circular body.

12. The expandable ice chute of claim 1, wherein the circular body tapers away from the hose attaching end towards the hose attaching end.
